(19) United States
(12) Patent Application Publication
(10) Pub. No.: US 2022/0277018 A1
(43) Pub. Date: Sep. 1, 2022

(54) ENERGY DATA PLATFORM

(71) Applicant: Microsoft Technology Licensing, LLC, Redmond, WA (US)

(72) Inventors: Mehmet Kadri UMAY, Redmond, WA (US); Imran SIDDIQUE, Bellevue, WA (US); Hari Krishnan SRINIVASAN, Redmond, WA (US); Nayana Singh PATEL, Mercer Island, WA (US)

(73) Assignee: Microsoft Technology Licensing, LLC, Redmond, WA (US)

(21) Appl. No.: 17/322,719

(22) Filed: May 17, 2021

Related U.S. Application Data
(60) Provisional application No. 63/200,287, filed on Feb. 26, 2021.

(51) Int. Cl. G06F 16/25; G06F 16/23; G06F 16/188; G06F 9/54

(52) U.S. Cl. CPC G06F 16/258; G06F 16/2372; G06F 16/2358; G06F 16/2365; G06F 16/188; G06F 9/547

(57) ABSTRACT

Examples are disclosed that relate to an energy data platform. One example provides a method comprising receiving a first energy data set having a first data format, and a second energy data set having a second data format, and ingesting the first energy data set and the second energy data set by automatically converting one or more of the first energy data set and the second energy data set into a standard data format. The method further comprises receiving a request from a first application to provide the first energy data set in the first data format, and in response, providing the first energy data set in the first data format, and receiving a request from a second application to provide the first energy data set in the standard data format, and in response, providing the first energy data set in the standard data format.

### CROSS REFERENCE TO RELATED APPLICATIONS

This application claims priority to U.S. Provisional Patent Application Ser. No. 63/200,287, filed Feb. 26, 2021, and entitled ENERGY DATA PLATFORM, the entirety of which is hereby incorporated herein by reference for all purposes.

### BACKGROUND

Energy companies can generate large amounts of data from such activities as energy exploration, production, transport, and usage. Such energy-related data may assume a variety of types and formats.

### SUMMARY

Examples are disclosed that relate to the processing and storage of diverse sets of energy data on a cloud-accessible computing platform. One example provides a method of operating an energy data platform. The method comprises receiving a first energy data set having a first data format, receiving a second energy data set having a second data format, and ingesting the first energy data set and the second energy data set by automatically converting one or more of the first energy data set and the second energy data set into a standard data format. The method further comprises receiving a request from a first application to provide the first energy data set in the first data format, and in response, providing the first energy data set in the first data format, and receiving a request from a second application to provide the first energy data set in the standard data format, and in response, providing the first energy data set in the standard data format.

Another example provides a computing system configured to implement an energy data platform for ingesting and processing energy data from remote sources. The computing system comprises a logic subsystem comprising one or logic devices configured to execute instructions, and a storage subsystem comprising one or more storage devices. The one or more storage devices comprise computer-readable instructions executable by the logic subsystem to receive a first energy data set of a first data type having a first data format, to receive a second energy data set of the first data type having a second data format different from the first data format, ingest the first energy data set and the second energy data set by automatically converting one or more of the first energy data set and the second energy data set into a standard data format, receive a request from a first application to provide the first energy data set in the first data format, and in response, provide the first energy data set in the first data format, and receive a request from a second application to provide the first energy data set in the standard data format, and in response, provide the first energy data set in the standard data format.

Another example provides a computing system configured to implement an energy data platform for ingesting and processing energy data from remote sources. The energy data platform comprises a logic subsystem comprising one or logic devices configured to execute instructions, and a storage subsystem comprising one or more storage devices. The one or more storage devices comprise computer-readable instructions executable by the logic subsystem to ingest, via an ingestion pipeline and using a first API, a first energy data set of a first data type, ingest, via the ingestion pipeline and using a second API, a second energy data set of a second data type, and provide the first energy data set and the second energy data set in one or both of a standard data format and a non-standard data format.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example system for ingesting, processing, storing, and providing energy data.

FIG. 2 schematically shows an example architecture that may be implemented at least in part by the system of FIG. 1.

FIG. 3 shows a flowchart illustrating an example method of ingesting and providing energy data sets in different data formats.

FIG. 4 shows a flow diagram illustrating an example scenario in which energy data is ingested into the open energy platform of FIG. 1 and provided in response to search queries.

FIG. 5 schematically shows another example architecture that may be implemented at least in part by the open energy platform of FIG. 1.

FIG. 6 shows a block diagram of an example computing system.

### DETAILED DESCRIPTION

Energy companies can produce large volumes of data, such as data generated from energy exploration, energy production, energy transport, and/or usage. Such energy-related data may assume a variety of types and formats. This variety may result at least in part from the wide variety of energy sources, such as various hydrocarbon and renewable sources, for which data formats have been developed, including standard and proprietary formats. For example, a same type of data may be encoded in different formats that are proprietary to companies that produce the data. As a more specific example, seismic data collected as part of oil exploration may be encoded in formats that are specific to various seismic testing companies. This diversity in type and format of energy data has led to the development of a fragmented ecosystem of tools and services designed for specific data types, formats, and energy sources. As such, an application designed to process energy data of a first type may be unable to interface with another application designed to process energy data of a second, different type and/or data of the second type itself. This may pose challenges for integrated energy companies that engage in a combination of upstream, midstream, and downstream activities, and/or energy companies that utilize a variety of energy sources. Fragmentation may also manifest in the distribution of energy data, which may be dispersed among a variety of devices in different physical locations. For example, energy data may be collected on-premises at the site of an energy source, whereas computing devices assigned to the processing of energy data may be remotely located from the site of the energy source. This fragmentation in energy data type and format, tools and services for processing energy data, and energy data storage tends to increase the cost and complexity of storing and processing energy data, increase the latency of transmitting and processing energy data, and potentially lead companies to create custom tools for converting and interfacing between different data types, formats, applications, and devices.

Accordingly, examples are disclosed that relate to an energy data platform implemented on a cloud computing service. The energy data platform is configured to receive, for any number of different types of energy data, energy data of different formats, and convert received energy data into standard data formats. The energy data platform may then provide an energy data set, for example to a requesting application in the standard data format or any other supported format. The conversion of data into a standard data format enables an ecosystem of applications—which may potentially be designed for different energy sources and contexts—to intake, process, and/or output energy data via a common framework. In addition, the support of non-standard data formats may enable legacy and proprietary applications to interface with energy data and the overall energy data platform. As such, the energy data platform may provide an integrated environment in which an array of energy data types and formats may be ingested, processed, and accessed. In some examples, the energy data platform may support access to energy data collected as part of upstream, midstream, and downstream activities. The energy data platform may further provide tools for processing energy data, such as artificial intelligence tools and metadata extraction, and tools for building applications that interface with the energy data platform.

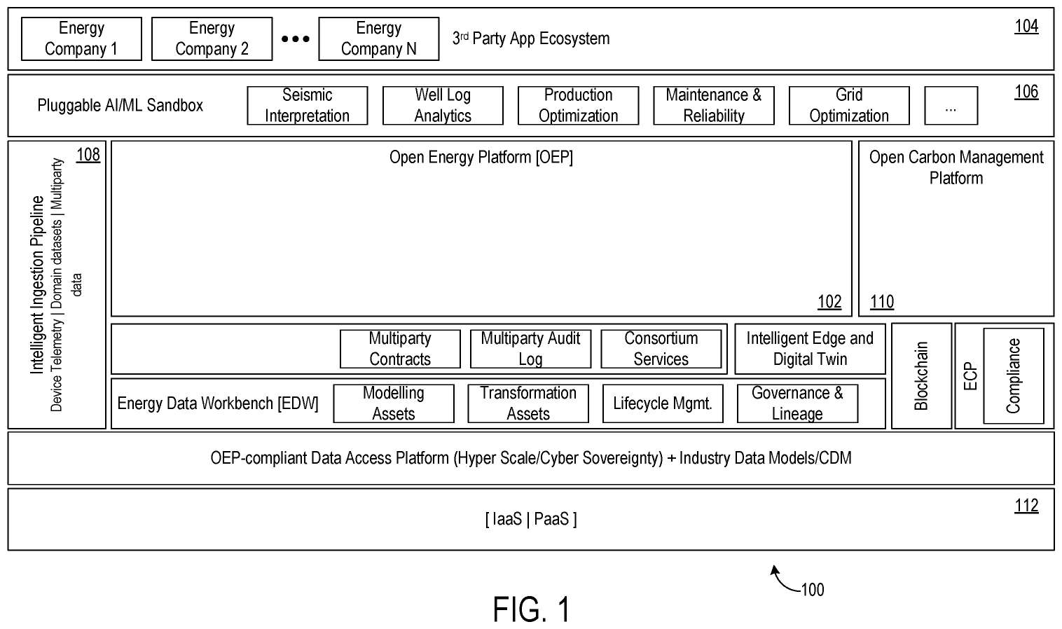

FIG. 1 schematically shows an example system 100 for processing energy data. System 100 includes an energy data platform 102 configured to receive energy data sets of differing data type and format, and intake the energy data sets by automatically converting one or more energy data sets into one or more different data formats, such as a standard format. Platform 102 may receive a request from a first application to provide an energy data set in a non-standard data format, such as a proprietary or legacy data format, and in response provide the energy data set in the non-standard data format. Platform 102 may further receive a request from a second application to provide the energy data set in the standard data format, and in response, provide the energy data set in the standard format. Platform 102 may be configured to provide energy data to any suitable type of application. As examples, a requesting application may be a third-party application (from the perspective of platform 102), an application offered by the platform, an application executed on the platform, and/or an application executed remotely from the platform. Further, as indicated at 104, an ecosystem of third-party applications created and/or operated by one or more energy companies or other energy-related entities may interface with platform 102 to intake, process, and/or output energy data. In some examples a third-party application may be built using tools offered by platform 102, as described below.

As indicated at 106, platform 102 may include or interface with tools for processing ingested energy data. As described below, such tools may include but are not limited to machine learning tools, artificial intelligence tools, analytic tools, and metadata extraction. Examples of such tools are illustrated as seismic interpretation, well log analytics, product optimization, maintenance and reliability, and grid optimization. Further, platform 102 may include or interface with an ingestion pipeline 108 for ingesting energy data in variety of manners from different sources. As described below, pipeline 108 may support manual ingestion by clients, automatic ingestion, ingestion of data copied or streamed into platform 102, ingestion from sensor systems, and/or ingestion from file or data sources. Pipeline 108 may thus function, in some examples, as a common ingestion point for a diverse array of data types produced by a diverse array of data sources which, in other systems, may otherwise merit ingestion via multiple different pipelines adapted to different data types and/or data sources. Pipeline 108 may further function as a multi-API (application programming interface) endpoint, allowing, for example, different data types to be appropriately routed to different platforms in system 100. As examples, pipeline 108 may ingest one or more of device telemetry, domain datasets, and multiparty data. Further, in some examples, pipeline 108 may be used to ingest energy data directly into platform 102, such as energy data in industry-specific formats. As another example, pipeline 108 may ingest energy data into a ledger implemented by a blockchain component of platform 102. Alternatively or additionally, pipeline 108 may be used to ingest energy data at entities other than platform 102, such as a common data model, a canonical data model, an industry data model, or a scene application. As pipeline 108 may be used to ingest energy data into a variety of entities, FIG. 1 depicts the pipeline as spanning multiple layers of system 100. As indicated at 110, platform 102 may interface with other energy-related platforms, such as a carbon management platform that enables the processing of carbon-related energy data such as data regarding greenhouse gas emissions based upon sensor data received at the carbon management platform.

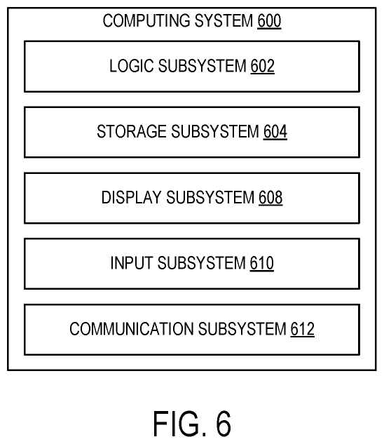

Platform 102 is implemented on a cloud computing service 112, wherein the term “cloud computing service” represents a range of computing services, including compute power and data storage (illustrated as Infrastructure as a Service (IaaS) and Platform as a Service (PaaS)), delivered on-demand via the internet. Cloud computing service 112 may implement any suitable computing hardware to enable the functionality of platform 102 described herein. Example hardware may include but is not limited to server computers, networking devices, processors, hard disks, tape storage, and/or infrastructure components. In some examples, the cloud computing service may take the form of one or more data centers (e.g. a plurality of geographically dispersed data centers) with multiple compute and storage nodes, and distribute computing workloads across a plurality of compute nodes. Further, cloud computing service 112 may provide different types of logical and/or physical storage. More detail regarding example computing hardware is described below with reference to FIG. 6. Platform 102 also may leverage other services implemented on cloud computing system 112, such as industry models, a data access platform, modelling assets, transformation assets, lifecycle management, governance, lineage, multiparty contracts, audit logs, consortium services, intelligent edge, digital twin, CDM, a digital twin service for modeling physical systems, blockchain, database services, container and virtualization services, and ECP including compliance. Generally, cloud computing service 112 may provide an infrastructure—physically and/or logically—on which platform 102 and its services described herein may be implemented.

It will be understood that platform 102 may be implemented in any suitable manner, and that one or more of the components in system 100 may be integrated with, or provided separately from, the platform. As examples, ingestion pipeline 108 and/or carbon management platform 110 may be implemented as part of, or separately from, platform 102. Moreover, it will be understood that platform 102 may be utilized for any suitable purpose relating to the processing of energy data, and for any suitable energy source. As examples, platform 102 may be utilized as part of oil/gas exploration, oil recovery, hydraulic fracturing, greenhouse gas tracking, agriculture, forestry, algae generation, wetland generation, etc.

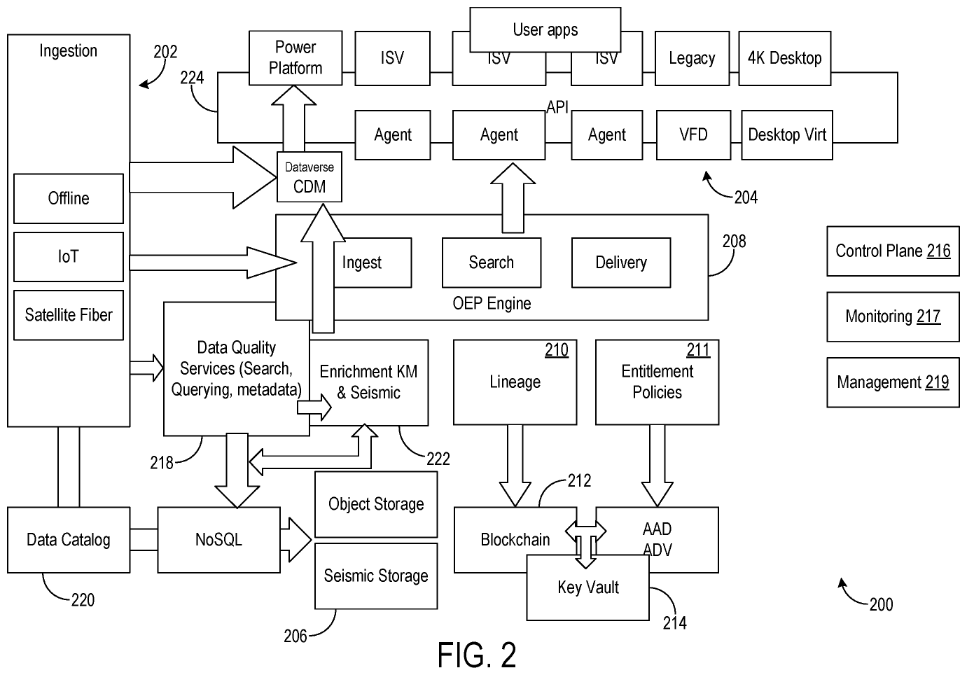

FIG. 2 schematically shows an example architecture 200 that may be implemented at least in part by open energy platform 102. Architecture 200 includes an ingestion pipeline 202 configured to ingest energy data from any suitable source, including but not limited to internet-of-things (IoT) devices (which may supply telemetry or sensor data), sensors, edge devices, satellite sources, fiber sources, and offline sources (e.g. for large files) as examples. Ingestion pipeline 202 may be implemented as part of platform 102, or separately from the platform (e.g. as ingestion pipeline 108), for example. Data may be ingested into platform 102 via ingestion pipeline 202 on any suitable basis. In some examples, pipeline 202 may ingest a stream of data as it is produced (e.g. by a sensor system that continuously outputs sensor data). In other examples, pipeline 202 may ingest data in batches scheduled on any suitable time frame (e.g. micro batching, hourly batching, daily batching).

In some examples a data source may export compressed data for ingestion by pipeline 202, and/or may selectively transmit changes in data without resending unchanged portions of the data. In other examples a data source may export raw data for ingestion by pipeline 202. In other examples, a data source may perform an analysis (e.g. anomaly detection) of collected data before exporting the data for ingestion by pipeline 202. Detection of an anomaly at the data source may prompt a change in the exportation of data by the data source, such as an increase in the frequency of exporting data.

In some examples, pipeline 202 may support data ingestion via multiple APIs. As examples, different APIs may be used to ingest different types of energy data, energy data from different sources or device types, energy data from different vendors or companies, and/or energy data from different phases of an energy-related endeavor. In a particular example, a first API may be used to ingest energy data of a first data type (e.g., seismic data) via pipeline 202, and a second API may be used to ingest energy data of a second data type (e.g., drilling data) different from the first data type via the pipeline. As such, pipeline 202 may provide a common ingestion mechanism for a diverse array of energy data, in turn helping to consolidate the processing of general energy data at platform 102. In contrast, other platforms configured to process energy data may provide multiple different ingestion pipelines to ingest energy data, potentially creating a complex and fragmented ecosystem of tools for processing energy data and a siloed distribution of energy data while utilizing more computing resources.

Architecture 200 may include one or more virtual file drivers (VFDs) 204. As described above, platform 102 may provide various storage services including but not limited to blob storage. An application configured to read blob data may ingest blob data by connecting to a stream of the blob data, for example. However, some applications (e.g. legacy applications) are configured to read data provided in a file system and not in blob storage. As such, VFDs 204 may expose energy data (which may potentially be stored in blob storage) in one or more file systems or file shares. A client device or application may then read the exposed energy data as provided in a file system/share, accessing the data via any suitable mechanism (e.g. a virtual desktop infrastructure (VDI)). In some examples, an application that interacts with energy data provided by platform 102 may be executed on the platform. In these examples, the application and/or its output may be accessed via VDI techniques. In other examples, an application that interacts with energy data provided by platform 102 may be executed on a computing system remote from the platform.

FIG. 2 also depicts seismic storage 206 at which seismic data may be stored, as an example of an energy data type that can be stored for client access. In some examples, seismic data may be stored in a seismic data format, such as the log ASCII standard (LAS) format. Seismic storage 206 may implement any suitable storage device(s), including but not limited to tape storage or other “cold” storage (e.g. for data that is not expected to be accessed frequently, and/or high-end storage (e.g. solid state drives (SSD) and/or hard disk drives (HDD)). Seismic storage 206 may be integrated within platform 102 or provided separately from the platform. In some examples, seismic storage 206 may be implemented at the premises of the site at which seismic data is collected, e.g. via an edge device. Other examples of potential data sources or storage services that may interface with platform 102 include but are not limited to a data catalog, no SQL database, and object storage service (e.g., blob storage service).

Via an engine 208, architecture 200 may facilitate conversion of energy data from an originating data format to a standard data format. For example, engine 208 may be used to convert data from a proprietary data format to a standard data format. Engine 208 may further facilitate one or more of data ingestion, searching, and delivery. Generally, engine 208 may utilize or cooperate with the components of architecture 200 to enable clients to ingest, process, and analyze energy data using services provided by the architecture, services provided by clients, serviced provided by third parties, and/or services developed using APIs and/or SDKs provided by the architecture.

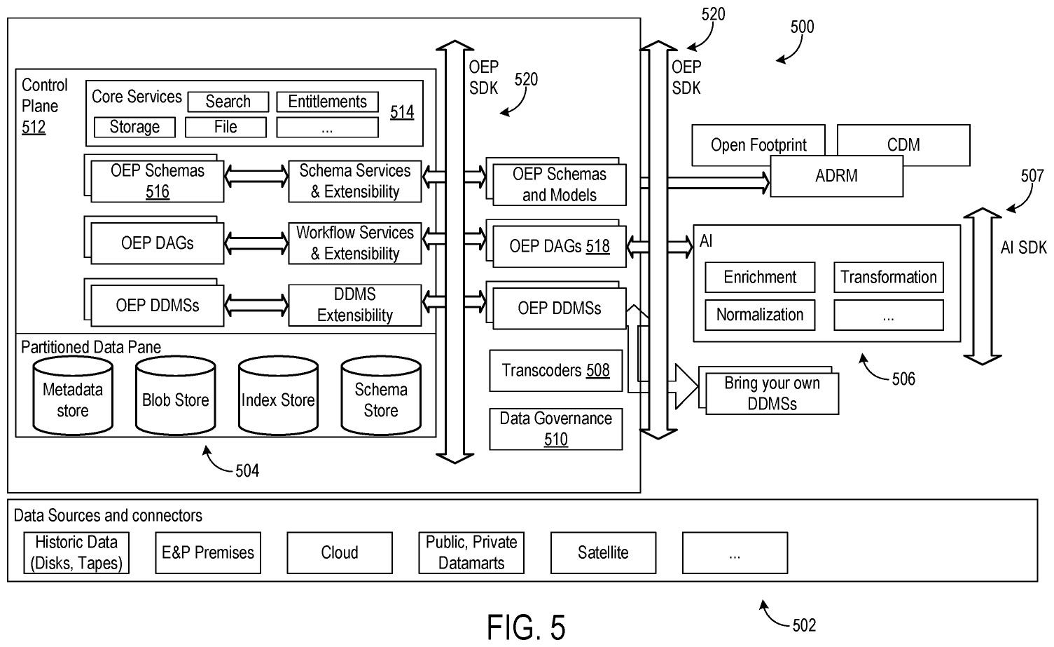

Via a lineage module 210, information regarding energy data such as the conversion of energy data may be made available to clients, including but not limited to an identification of a device and/or user that initiated a conversion, and a time at which the conversion took place. As another example, a report produced based on energy data ingested into platform 102 may be fed back into the platform, with lineage module 210 being used to track the lineage of this process and the data involved. Lineage module 210 may thus be used to track relationships in data and relationships among data and other entities such as clients, aspects of a site at which data is collected, and/or any other suitable information. Further, lineage module 210 may maintain information regarding the provenance of energy data, which for example may be used by government entities, policy makers, or auditors. Data managed by lineage module 210 may be encoded in one or more graphs, as one example, or via any other suitable mechanism. Via an entitlement policy module 211, client access to data and/or services at platform 102 may be dynamically managed, for example according to entitlements, access policies, and/or credentials. In other words, policy module 211 may enable role-based access control to energy data. Further, a blockchain module 212 may enable the implementation of blockchain-related systems and data storage. One example of such a blockchain-related system includes a ledger configured to record transactions regarding carbon trading. A key vault 214 module may facilitate encrypted communication and data storage through the exchange and use of encryption/decryption keys. A control plane 216 may enable client-related activities including but not limited to developer operations, billing, and reporting, as described in further detail below with reference to FIG. 5. A monitoring module 217 may enable monitoring-related activities (e.g. monitoring data quality). A management module 219 may enable management-related activities (e.g. access control, data management).

Architecture 200 may include one or more data quality services 218. Services 218 include but are not limited to data quality checking. As one example, a client may ingest energy data via pipeline 202, extract various features from the energy data, and leverage services 218 to evaluate the quality of the extracted features. Data quality checking may be implemented by policies set by clients, for example. Further, data quality checking may involve checking a file header (e.g., to identify fields to populate), checking energy data for anomalies, and/or any other suitable action. In some examples, data quality services 218 may be integrated with a data catalog 220. In such examples, information regarding the quality of energy data determined via services 218 may be cataloged along with the energy data itself. A dashboard or other user interface may be used to explore the energy data on a quality basis, and may potentially indicate where energy data of various quality levels originated from and/or is stored. This may allow clients to identify segments of energy data where higher data quality is desired.

Architecture 200 may include one or more data enrichment services 222. Services 222 may be used to extract additional data (e.g., beyond quality data produced by services 218) from energy data, for example. Such additional data may include but is not limited to metadata (e.g., authorship, topics, file header information), image data, taxonomic data, and anthological data. Data extracted via services 222 may be cataloged in data catalog 220. Further, in some examples, enrichment services 222 may be exposed through a common data model infrastructure that is in turn exposed to low-code or no-code environments such as a power platform 224. In some examples, lineage and/or provenance of data may be determined (via lineage module 210) following enrichment via enrichment services 222.

In further examples, architecture 200 may be used to create metadata from ingested energy data in a JavaScript Object Notation (JSON) data format, though metadata may be encoded in any suitable data format (e.g. extensible markup language (XML)). In some examples, architecture 200 may support manifest based ingestion. Further, architecture 200 may include an artificial intelligence (AI) SDK with which tools and services can be executed on ingested energy data. Such tools and services may include but are not limited to data quality checking, knowledge (e.g metadata) extraction, and data fusion. Metadata may be extracted in architecture 200 from energy data, generated from a database, or produced via any other suitable mechanism. As a particular example, a metadata enrichment tool may be used to extract header information in the form of seismic attributes from a seismic data file, and add one or more of the seismic attributes to an original schema to thereby produce an enriched schema.

Architecture 200 may includes a client SDK with which third-party applications may search and extract energy data from platform 102. The client SDK may enable a variety of different searching mechanisms for accessing energy data, including but not limited to AZURE (provided by Microsoft Corporation of Redmond, Wash.) search-based syntax, link drivers, and SQL queries. In some examples, an artifact generated by a client may be ingested (e.g. directly) back into platform 102 via the client SDK. An end user application or independent software vendor (ISV) may utilize the client SDK to search for energy data on platform 102, for example. Moreover, architecture 200 may include a domain extension SDK with which clients can extend services beyond what is offered by platform 102. Platform 102 may provide extensibility (e.g. through SDKs, APIs, connectors), of the functions provided by the platform, as a service.

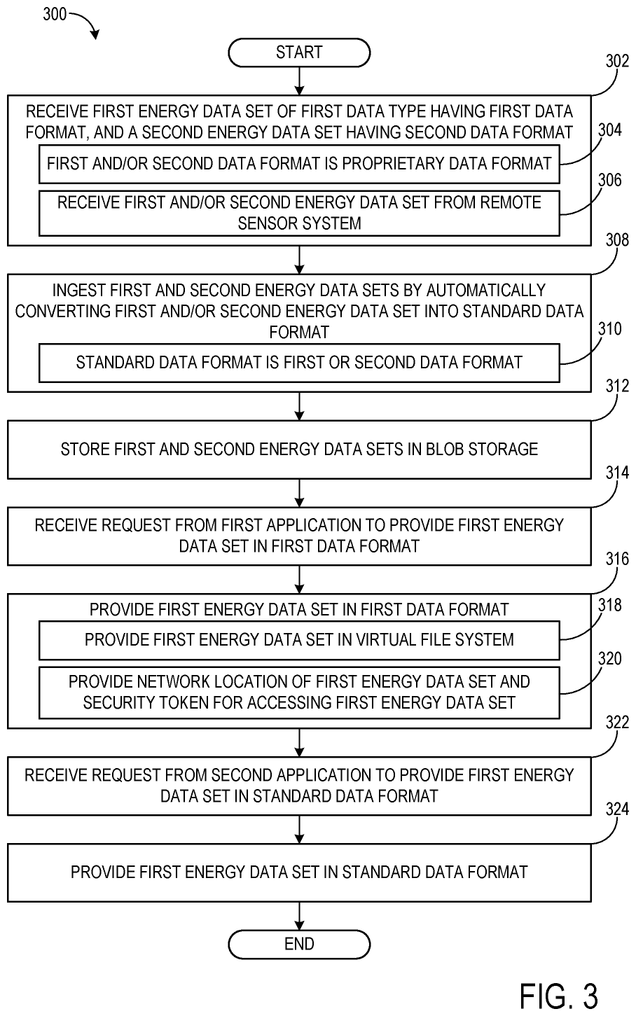

FIG. 3 shows a flowchart illustrating an example method 300 of providing energy data sets in different data formats. Method 300 may be implemented at least in part via system 100 and/or architecture 200, for example. At 302, method 300 includes receiving a first energy data set of a first data type having a first data format, and a second energy data set of the first data type having a second data format different from the first data format. The first data type and/or the second data type may be 304 a proprietary data format (e.g. a non-standard data format), or one or the other may be a standard data format. The first energy data set and/or the second energy data set may be received 306 from remote computing systems, and may be received from a same entity or from different entities.

At 308, method 300 includes ingesting the first energy data set and the second energy data set by automatically converting one or more of the first energy data set and the second energy data set into a standard data format. The standard data format may be 310 the first data format or the second data format, or may be a third format different from the first format and the second format.

At 312, method 300 includes storing the first energy data set and the second energy data set in blob storage, or other suitable storage (e.g. file, table or other type of storage). At 314, method 300 includes receiving a request from a first application to provide the first energy data set in the first data format. At 316, method 300 includes, in response to the request, providing the first energy data set in the first data format. In some examples where the standard data format is different from the first data format, providing the first energy data set in the first data format may include converting the first energy data set into the standard data format. Providing the first energy data set may include providing 318 the first energy data set in a virtual file system. Further, in some examples, providing the first energy data set may include providing 320 a network location of the first energy data set and a security token for accessing the first energy data set.

At 322, method 300 includes receiving a request from a second application to provide the first energy data set in the standard data format. At 324, method 300 includes, in response to the request, providing the first energy data set in the standard data format.

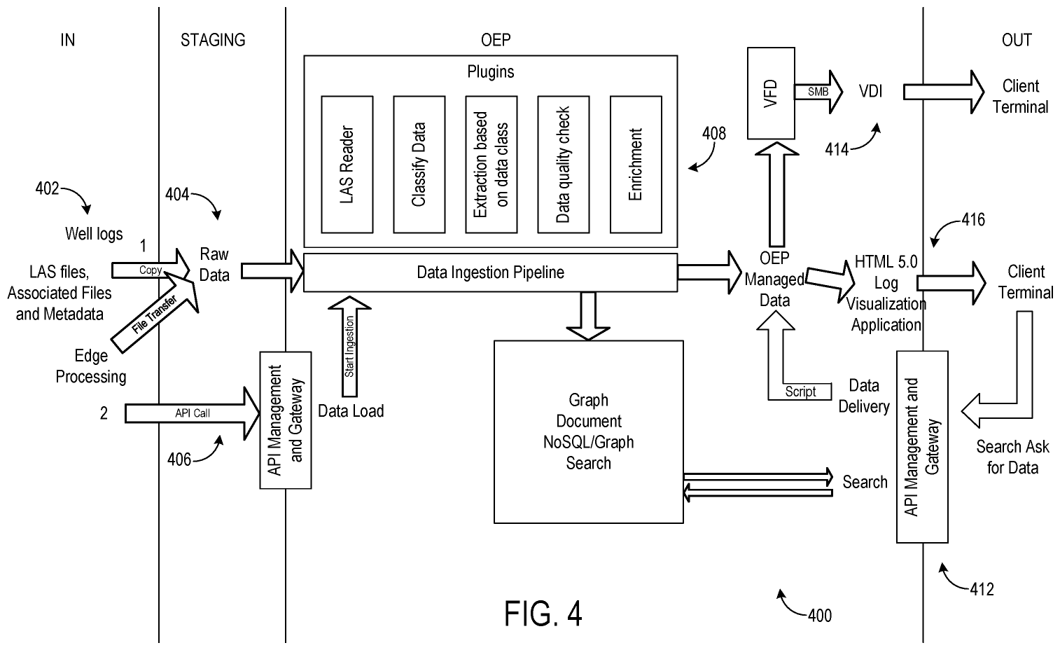

FIG. 4 shows a flow diagram 400 illustrating an example scenario in which energy data in the form of well log data is ingested into platform 102 and made accessible to clients of the platform. The well log data may be stored in an LAS data format and comprise a series of recordings as a function of depth, for example. As indicated at 402, the well log data set may be ingested into platform 102 in a variety of manners, such as by copying the data set into blob data storage and ingesting the blob data into the platform, as indicated at 404. In other examples, an edge computing device (e.g. a computing device that is located at a customer location between a customer's computing system or network and the internet or other wide-area network to bring some cloud services to the customer's location) may export well log data for ingestion. In such an example, the edge device may export data as aggregated data, through an IoT infrastructure, and/or in any other suitable manner. In some examples, the edge device may support the export of data while the data is collected (e.g. in accordance with logging while drilling techniques). In other examples, as indicated at 406, the well log data set may be ingested into platform 102 via a call to an API, which may be provided by the platform. The use of an API call to ingest data may represent a manual approach to ingesting data in which the API call is manually invoked by a client. Conversely, ingestion by copying data into a blob or through export from an edge device may represent an automatic approach to ingesting data in which the ingestion process is initiated upon receiving data at platform 102 via the blob or edge device.

As indicated at 408, platform 102 may provide various tools, services, applications, or plugins for processing the ingested well log data set. Examples of such tools include but are not limited to a LAS file reader, which may parse a header portion and a body portion of LAS files, classifier tools for classifying data, extraction tools, which may extract metadata from LAS files as parsed by the LAS file reader, data quality analysis tools, and data enrichment tools, which may be used to derive additional metadata (e.g. metadata in addition to metadata extracted from an LAS file by the LAS file reader). In some examples, the extraction tools may be used to extract metadata from well log data. In other examples, pre-extracted metadata may be ingested along with the well log data.

As indicated at 410, metadata may be used to construct a graph based on the ingested well log data set. The graph may encode relationships in the well log data set. In some examples, the graph may be stored in a database (e.g. a document database, noSQL database). The well log data may then be accessed by traversing the graph, for example by invoking an API call, as indicated at 412. As one example of how a graph may be used, the graph may be searched to find analogs (e.g. as part of oil and gas exploration). As another example of mechanisms by which well log data may be accessed by clients, FIG. 4 shows at 414 access by a client device to well log data exposed in a virtual file system via a VFD through a VDI mechanism. As yet another example, FIG. 4 further shows at 416 access to well log data by a client device through an HTML 5.0 application. Upon ingesting the well log data set, platform 102 may provide clients with a network location of the well log data and a security token for accessing the well log data. The security token may include credentials, encryption key(s), or any other suitable information. It will be understood that platform 102 may provide access to energy data that is hosted in a storage service (e.g. a blob storage service) provided by the platform, or by a service hosted externally to the platform (e.g. a seismic data storage service). In view of the above, platform 102 may provide different endpoints and/or access methods for accessing data hosted in different storage services—for example, an API may be provided for accessing data stored in the blob data storage service. Further, FIG. 4 also depicts various functions and services (graphs, document database, NoSQL database, and searching) that may be utilized as part of processing well log data. One or more of such function/services may be implemented at engine 208 of FIG. 2, for example.

Additional example scenarios in which platform 102 may be used to ingest energy data include hydraulic fracturing, in which data regarding emissions resulting from the fracturing process is ingested into the platform, and oil recovery, in which the platform may be used to track carbon credits for use in oil recovery. In yet another example, energy data (e.g. well log data) may be ingested into platform 102 from a plurality of dispersed geographic locations and used to construct a graph that is traversed to find analogs of the locations for which data was ingested. Yet other examples of energy data that may be ingested into platform 102 include energy data derived from midstream activities, such as energy data relating to energy transport (e.g., pipelines, trucking, railroading), and energy data derived from downstream activities, such as energy data relating to refinement, purification, processing (e.g. chemical manufacturing), marketing, and/or distribution. Still further, energy data relating to windmills, carbon sequestration, solar power, biomass energy production, and hydroelectricity may be ingested into platform 102, as additional examples.

In some examples, platform 102 may be configured to determine usage patterns regarding the usage of ingested energy data, and copy energy data to storage facilities based on the usage patterns. For example, an energy data set may be stored at a physical storage facility located in a first geographic region (e.g. a region at which the energy data set is generated, such as the site of an energy source). Platform 102 may identify usage patterns indicating usage of the energy data set from a different region (e.g. repeated accessing of the energy data from a location closer to a different data center), and in some examples may automatically copy the energy data set to a data center in the other region (e.g. a different production region at which an entity operating at the first geographic region also operates). As another example, platform 102 may copy energy data from one region to another region in response to identifying data indicating analogous energy sources in the different regions. Further, platform 102 may consider storage costs in copying data to different regions. For example, a client of platform 102 may utilize a data storage service (integrated within the platform or provided externally to the platform) that offers different tiers of storage at different costs. Upon identifying an access pattern that merits energy data to be copied from one region to another region, platform 102 may determine a storage scheme for the other region that optimizes cost in view of factors such as client requirements, client preferences, attributes of the data to be copied, and/or any other suitable consideration.

FIG. 5 schematically shows an example architecture 500 that may be implemented at least in part by platform 102. As indicated at 502, platform 102 can ingest energy data from a variety of sources, including hard disk storage, tape storage, on-premises sensor systems, a cloud computing service, a data mart, and satellite data source. As indicated at 504, platform 102 may implement different logical and/or physical data stores for different data types, including but not limited to metadata, blob data, index data, and schema data. As indicated at 506, platform 102 may implement one or more AI tools or services, for example relating to data enrichment, transformation, and normalization. Module 506 may also represent support for the extensibility of AI tools and services. AI tools/services 506 may be exposed to clients via APIs and/or SDKs indicated at 507. Architecture 500 further provides transcoding functionality, as indicated at 508, for converting energy data into different data formats, and data governance, as indicated at 510, for providing client visibility into attributes of energy data and its processing.

Architecture 500 also includes a control plane 512 that may generally represent functions and services exposed to clients. Such functions and services may include schema services and extensibility, workflow services and extensibility, developer operations, billing, and DDMS extensibility. Control plane 512 may enable the integration of third-party applications, telemetry, and other types of extensibility with respect to platform 102. Control plane 512 may further be used to implement platform 102 on cloud computing service 112. Control plane 216 of FIG. 2 may implement aspects of control plane 512, for example.

Control plane 512 includes core services 514, including but not limited to searching, storage, file services, and entitlements. The management of entitlements may include defining policies for entitlements, as one example. Control plane 512 further includes a schema module 516 with which schemas may be defined, loaded into platform 102, visualized, added/removed/updated, and/or validated. In some examples, schemas may be connected to a schema service and thereby be implemented in platform 102.

Architecture 500 may include one or more extensibility managers 518 with which the functionality of platform 102 may be extended, for example to implement a data management or orchestration service. A client extending the functionality of platform 102 by building a new application may interface the application with the platform via extensibility managers 518, for example. Extensibility managers 518 may be exposed to clients via APIs and/or SDKs indicated at 520. Further, in some examples, various components of architecture 500 may be external-facing and exposed to clients (e.g. through APIs and/or SDKs), while other components may be internal-facing and not exposed to clients.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 is shown in simplified form. Computing system 600 can represent any computing system on which any of the examples of FIGS. 1-6 can be implemented. Computing system 600 may take the form of one or more personal computers, server computers, tablet computers, home-entertainment computers, network computing devices, gaming devices, mobile computing devices, mobile communication devices (e.g. smart phone), and/or other computing devices, and wearable computing devices such as smart wristwatches and head mounted augmented reality devices.

Computing system 600 includes a logic subsystem 602 and a storage subsystem 604. Computing system 600 may optionally include a display subsystem 608, input subsystem 610, communication subsystem 612, and/or other components not shown in FIG. 6.

Logic subsystem 602 includes one or more physical devices configured to execute instructions. For example, the logic subsystem may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more physical processors (hardware) configured to execute software instructions. Additionally or alternatively, the logic subsystem may include one or more hardware logic circuits or firmware devices configured to execute hardware-implemented logic or firmware instructions. Processors of the logic subsystem 602 may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration. In such a case, these virtualized aspects are run on different physical logic subsystems of various different machines, it will be understood.

Storage subsystem 604 includes one or more physical devices configured to hold instructions executable by the logic subsystems to implement the methods and processes described herein. When such methods and processes are implemented, the state of storage subsystem 604 may be transformed—e.g. to hold different data.

Storage subsystem 604 may include physical devices that are removable and/or built-in. Storage subsystem 604 may include optical memory (e.g. CD, DVD, HD-DVD, Blu-Ray Disc, etc.), semiconductor memory (e.g. ROM, EPROM, EEPROM, FLASH memory, etc.), and/or magnetic memory (e.g. hard-disk drive, floppy-disk drive, tape drive, MRAM, etc.), or other mass storage device technology. Storage subsystem 604 may include nonvolatile, dynamic, static, read/write, read-only, sequential-access, location-addressable, file-addressable, and/or content-addressable devices. It will be appreciated that storage subsystem 604 is configured to hold instructions even when power is cut to the storage subsystem 604.

Storage subsystem 604 may include physical devices that include random access memory. Storage subsystem 604 is typically utilized by logic subsystem 602 to temporarily store information during processing of software instructions. It will be appreciated that storage subsystem 604 typically does not continue to store instructions when power is cut to the storage subsystem 604.

Aspects of logic subsystem 602 and storage subsystem 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic subsystem 602 executing instructions held by storage subsystem 604, using portions of storage subsystem 604 (e.g., volatile memory). It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 608 may be used to present a visual representation of data held by storage subsystem 604. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic subsystem 602 and/or storage subsystem 604 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

Another example provides, enacted on an energy data platform implemented on a cloud computing service, a method comprising receiving a first energy data set of a first data type having a first data format, and a second energy data set of the first data type having a second data format different from the first data format, ingesting the first energy data set and the second energy data set by automatically converting one or more of the first energy data set and the second energy data set into a standard data format, receiving a request from a first application to provide the first energy data set in the first data format, and in response, providing the first energy data set in the first data format, and receiving a request from a second application to provide the first energy data set in the standard data format, and in response, providing the first energy data set in the standard data format. In some such examples, the standard data format alternatively or additionally is one of the first data format or the second data format. In some such examples, one or more of the first data format and the second data format alternatively or additionally is a proprietary data format. In some such examples, the method alternatively or additionally further comprises storing the first energy data set and the second energy data set in blob storage. In some such examples, providing the first energy data set alternatively or additionally comprises providing the first energy data set in a virtual file system. In some such examples, one or more of the first energy data set and the second energy data set alternatively or additionally are received from a remote sensor system. In some such examples, providing the first energy data set alternatively or additionally includes providing a network location of the first energy data set and a security token for accessing the first energy data set.

Another example provides a computing system configured to implement an energy data platform for ingesting and processing energy data from remote sources, the computing system comprising a logic subsystem comprising one or logic devices configured to execute instructions, and a storage subsystem comprising one or more storage devices, the one or more storage devices comprising computer-readable instructions executable by the logic subsystem to receive a first energy data set of a first data type having a first data format, and a second energy data set of the first data type having a second data format different from the first data format, ingest the first energy data set and the second energy data set by automatically converting one or more of the first energy data set and the second energy data set into a standard data format, receive a request from a first application to provide the first energy data set in the first data format, and in response, provide the first energy data set in the first data format, and receive a request from a second application to provide the first energy data set in the standard data format, and in response, provide the first energy data set in the standard data format. In some such examples, the standard data format alternatively or additionally is one of the first data format or the second data format. In some such examples, one or more of the first data format and the second data format alternatively or additionally is a proprietary data format. In some such examples, the computing system alternatively or additionally further comprises instructions executable to store the first energy data set and the second energy data set in blob storage. In some such examples, the instructions alternatively or additionally are executable to provide the first energy data set are further executable to provide the first energy data set in a virtual file system. In some such examples, one or more of the first energy data set and the second energy data set alternatively or additionally are received from a remote sensor system. In some such examples, the instructions executable to provide the first energy data set alternatively or additionally are executable to provide a network location of the first energy data set and a security token for accessing the first energy data set.

Another example provides a computing system configured to implement an energy data platform for ingesting and processing energy data from remote sources, the energy data platform comprising a logic subsystem comprising one or logic devices configured to execute instructions, and a storage subsystem comprising one or more storage devices, the one or more storage devices comprising computer-readable instructions executable by the logic subsystem to ingest, via an ingestion pipeline and using a first API, a first energy data set of a first data type, ingest, via the ingestion pipeline and using a second API, a second energy data set of a second data type, and provide the first energy data set and the second energy data set in one or both of a standard data format and a non-standard data format. In some such examples, the non-standard data format alternatively or additionally is a proprietary data format. In some such examples, one or more of the first energy data set and the second energy data set alternatively or additionally are ingested from an internet-of-things device. In some such examples, one or more of the first energy data set and the second energy data set alternatively or additionally are ingested from a sensor device. In some such examples, one or more of the first energy data set and the second energy data set alternatively or additionally are ingested from an offline source. In some such examples, the first energy data set and the second energy data set alternatively or additionally are stored in the standard data format at the computing system.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. Enacted on an energy data platform implemented on a cloud computing service, a method comprising:
receiving a first energy data set of a first data type having a first data format, and a second energy data set of the first data type having a second data format different from the first data format;
ingesting the first energy data set and the second energy data set by automatically converting one or more of the first energy data set and the second energy data set into a standard data format;
receiving a request from a first application to provide the first energy data set in the first data format, and in response, providing the first energy data set in the first data format; and
receiving a request from a second application to provide the first energy data set in the standard data format, and in response, providing the first energy data set in the standard data format.

2. The method of claim 1, wherein the standard data format is one of the first data format or the second data format.

3. The method of claim 1, wherein one or more of the first data format and the second data format is a proprietary data format.

4. The method of claim 1, further comprising storing the first energy data set and the second energy data set in blob storage.

5. The method of claim 4, wherein providing the first energy data set comprises providing the first energy data set in a virtual file system.

6. The method of claim 1, wherein one or more of the first energy data set and the second energy data set are received from a remote sensor system.

7. The method of claim 1, wherein providing the first energy data set includes providing a network location of the first energy data set and a security token for accessing the first energy data set.

8. A computing system configured to implement an energy data platform for ingesting and processing energy data from remote sources, the computing system comprising
a logic subsystem comprising one or logic devices configured to execute instructions; and
a storage subsystem comprising one or more storage devices, the one or more storage devices comprising computer-readable instructions executable by the logic subsystem to
receive a first energy data set of a first data type having a first data format, and a second energy data set of the first data type having a second data format different from the first data format;
ingest the first energy data set and the second energy data set by automatically converting one or more of the first energy data set and the second energy data set into a standard data format;
receive a request from a first application to provide the first energy data set in the first data format, and in response, provide the first energy data set in the first data format; and
receive a request from a second application to provide the first energy data set in the standard data format, and in response, provide the first energy data set in the standard data format.

9. The computing system of claim 8, wherein the standard data format is one of the first data format or the second data format.

10. The computing system of claim 8, wherein one or more of the first data format and the second data format is a proprietary data format.

11. The computing system of claim 8, further comprising instructions executable to store the first energy data set and the second energy data set in blob storage.

12. The computing system of claim 11, wherein the instructions executable to provide the first energy data set are further executable to provide the first energy data set in a virtual file system.

13. The computing system of claim 8, wherein one or more of the first energy data set and the second energy data set are received from a remote sensor system.

14. The computing system of claim 8, wherein the instructions executable to provide the first energy data set are further executable to provide a network location of the first energy data set and a security token for accessing the first energy data set.

15. A computing system configured to implement an energy data platform for ingesting and processing energy data from remote sources, the energy data platform comprising
a logic subsystem comprising one or logic devices configured to execute instructions; and
a storage subsystem comprising one or more storage devices, the one or more storage devices comprising computer-readable instructions executable by the logic subsystem to
ingest, via an ingestion pipeline and using a first API, a first energy data set of a first data type;
ingest, via the ingestion pipeline and using a second API, a second energy data set of a second data type; and
provide the first energy data set and the second energy data set in one or both of a standard data format and a non-standard data format.

16. The computing system of claim 15, wherein the non-standard data format is a proprietary data format.

17. The computing system of claim 15, wherein one or more of the first energy data set and the second energy data set are ingested from an internet-of-things device.

18. The computing system of claim 15, wherein one or more of the first energy data set and the second energy data set are ingested from a sensor device.

19. The computing system of claim 15, wherein one or more of the first energy data set and the second energy data set are ingested from an offline source.

20. The computing system of claim 15, wherein the first energy data set and the second energy data set are stored in the standard data format at the computing system.
